(19) United States
(12) Patent Application Publication
(10) Pub. No.: US 2024/0062771 A1
(43) Pub. Date: Feb. 22, 2024

(54) EXTRACTION DEVICE, EXTRACTION METHOD, TRAINING DEVICE, TRAINING METHOD, AND PROGRAM

(71) Applicant: NIPPON TELEGRAPH AND TELEPHONE CORPORATION, Tokyo (JP)

(72) Inventors: Marc DELCROIX, Musashino-shi, Tokyo (JP); Tsubasa OCHIAI, Musashino-shi, Tokyo (JP); Tomohiro NAKATANI, Musashino-shi, Tokyo (JP); Keisuke KINOSHITA, Musashino-shi, Tokyo (JP)

(73) Assignee: NIPPON TELEGRAPH AND TELEPHONE CORPORATION, Tokyo (JP)

(21) Appl. No.: 18/269,761

(22) PCT Filed: Jan. 5, 2021
(86) PCT No.: PCT/JP2021/000134

§ 371 Date: Jun. 27, 2023

(51) Int. Cl. G10L 25/30; G10L 25/03

(52) U.S. Cl. CPC G10L 25/30; G10L 25/03

(57) ABSTRACT

A learning device includes a conversion unit, a combination unit, an extraction unit, and an update unit. The conversion unit converts a mixed sound, of which sound sources for each component are known, into embedding vectors for each sound source using an embedding neural network. The combination unit combines the embedding vectors using a combination neural network to obtain a combined vector. The extraction unit extracts a target sound from the mixed sound and the combined vector using an extraction neural network. The update unit updates parameters of the embedding neural network such that a loss function calculated based on information regarding the sound sources for each component of the mixed sound and the target sound extracted by the extraction unit is optimized.

### TECHNICAL FIELD

The present invention relates to an extraction device, an extraction method, a learning device, a learning method, and a program.

### BACKGROUND ART

A speaker beam is known as technology for extracting a voice of a target speaker from mixed voice signals obtained from voices of a plurality of speakers (for example, refer to Non Patent Literature 1). For example, the method described in Non Patent Literature 1 includes a main neural network (NN) that converts a mixed voice signal into a time domain and extracts a voice of a target speaker from the mixed voice signal in the time domain, and an auxiliary NN that extracts a feature quantity from a voice signal of the target speaker, and estimates and outputs the voice signal of the target speaker included in the mixed voice signal in the time domain by inputting an output of the auxiliary NN to an adaptive layer provided in an intermediate part of the main NN.

### CITATION LIST

### Non Patent Literature

Non Patent Literature 1: Marc Delcroix, et al. “Improving speaker discrimination of target speech extraction with time-domain SpeakerBeam”, https://arxiv.org/pdf/2001.08378.pdf

### SUMMARY OF INVENTION

### Technical Problem

However, the conventional method has a problem that the target voice may not be accurately and easily extracted from the mixed voice. For example, in the method described in Non Patent Literature 1, it is necessary to register the voice of a target speaker in advance. In addition, for example, in a case where there is a time section in which the target speaker is not speaking (inactive section) in the mixed voice signal, there are cases where a voice of a similar speaker is erroneously extracted. Furthermore, for example, in a case where the mixed voice is a voice of a long meeting, the voice of the target speaker may change due to fatigue or the like in the course of the meeting.

### Solution to Problem

In order to solve the above-described problems and achieve the object, there is provided an extraction device including: a conversion unit that converts a mixed sound, of which sound sources for each component are known, into embedding vectors for each sound source using an embedding neural network; a combination unit that combines the embedding vectors using a combination neural network to obtain a combined vector; and an extraction unit that extracts a target sound from the mixed sound and the combined vector using an extraction neural network.

In addition, there is provided a learning device including: a conversion unit that converts a mixed sound, of which sound sources for each component are known, into embedding vectors for each sound source using an embedding neural network; a combination unit that combines the embedding vectors using a combination neural network to obtain a combined vector; an extraction unit that extracts a target sound from the mixed sound and the combined vector using an extraction neural network; and an update unit that updates parameters of the embedding neural network such that a loss function calculated based on information regarding the sound sources for each component of the mixed sound and the target sound extracted by the extraction unit is optimized.

### Advantageous Effects of Invention

According to the present invention, it is possible to accurately and easily extract a target voice from a mixed voice.

### BRIEF DESCRIPTION OF DRAWINGS

FIG. 1 is a diagram illustrating a configuration example of an extraction device according to a first embodiment.

FIG. 2 is a diagram illustrating a configuration example of a learning device according to the first embodiment.

FIG. 3 is a diagram illustrating a configuration example of a model.

FIG. 4 is a diagram for explaining an embedding network.

FIG. 5 is a diagram for explaining the embedding network.

FIG. 6 is a flowchart illustrating a flow of processing of the extraction device according to the first embodiment.

FIG. 7 is a flowchart illustrating a flow of processing of the learning device according to the first embodiment.

FIG. 8 is a diagram illustrating an example of a computer that executes a program.

### DESCRIPTION OF EMBODIMENTS

Hereinafter, embodiments of an extraction device, an extraction method, a learning device, a learning method, and a program according to the present application will be described in detail with reference to the drawings. Note that the present invention is not limited to the embodiments described below.

### First Embodiment

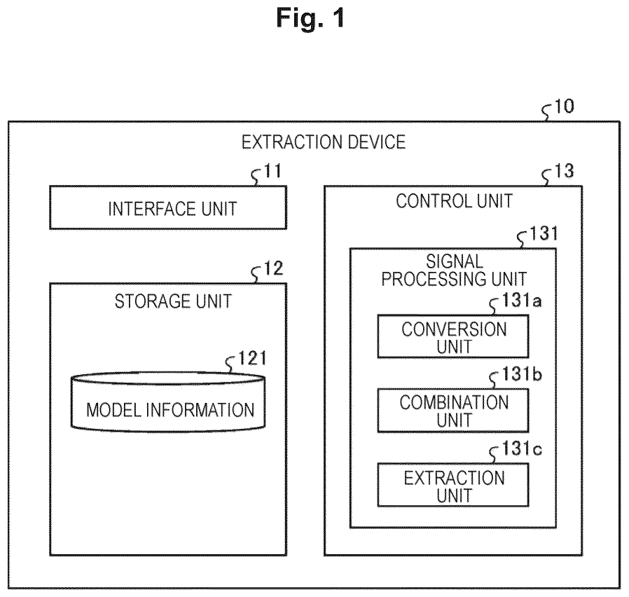

FIG. 1 is a diagram illustrating a configuration example of an extraction device according to a first embodiment. As illustrated in FIG. 1, the extraction device 10 includes an interface unit 11, a storage unit 12, and a control unit 13.

The extraction device 10 receives inputs of a mixed voice including voices from a plurality of sound sources. Furthermore, the extraction device 10 extracts voices of each sound source or a voice of a target sound source from the mixed voice and outputs the extracted voice.

In the present embodiment, it is assumed that the sound source is a speaker. In this case, the mixed voice is a mixture of voices uttered by a plurality of speakers. For example, the mixed voice is obtained by recording a voice of a meeting in which a plurality of speakers participate with a microphone. “Sound source” in the following description may be appropriately replaced with “speaker”.

The present embodiment can deal with not only a voice uttered by a speaker but also a sound from any sound source. For example, the extraction device 10 can receive an input of a mixed sound having an acoustic event such as a sound of a musical instrument or a siren sound of a car as a sound source, and extract and output a sound of a target sound source. Furthermore, “voice” in the following description may be appropriately replaced with “sound”.

The interface unit 11 is an interface for inputting and outputting data. For example, the interface unit 11 includes a network interface card (NIC). Moreover, the interface unit 11 may be connected to an output device such as a display, and an input device such as a keyboard.

The storage unit 12 is a storage device such as a hard disk drive (HDD), a solid state drive (SSD), or an optical disc. Note that the storage unit 12 may be a semiconductor memory capable of rewriting data, such as a random access memory (RAM), a flash memory, or a non-volatile static random access memory (NVSRAM). The storage unit 12 stores an operating system (OS) and various programs executed by the extraction device 10.

As illustrated in FIG. 1, the storage unit 12 stores model information 121. The model information 121 is a parameter or the like for constructing a model. For example, the model information 121 is a weight, a bias, and the like for constructing each neural network that will be described later.

The control unit 13 controls the entire extraction device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA). Further, the control unit 13 includes an internal memory for storing programs or control data defining various processing procedures, and executes each type of processing using the internal memory.

The control unit 13 functions as various processing units by various programs operating. For example, the control unit 13 includes a signal processing unit 131. Furthermore, the signal processing unit 131 includes a conversion unit 131a, a combination unit 131b, and an extraction unit 131c.

The signal processing unit 131 extracts the target voice from the mixed voice using the model constructed from the model information 121. The processing of each unit of the signal processing unit 131 will be described later. In addition, it is assumed that the model constructed from the model information 121 is a model trained by the learning device.

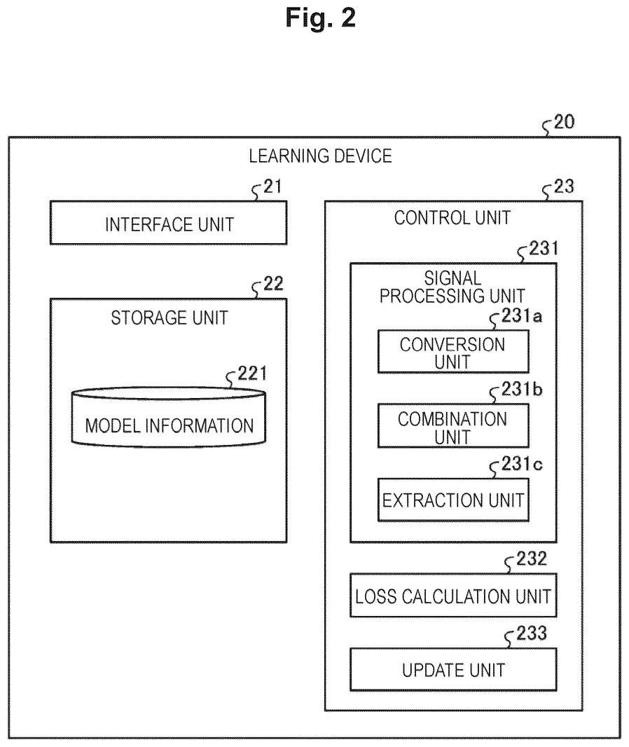

Here, the configuration of the learning device will be described with reference to FIG. 2. FIG. 2 is a diagram illustrating a configuration example of the learning device according to the first embodiment. As illustrated in FIG. 2, a learning device 20 has an interface unit 21, a storage unit 22, and a control unit 23.

The learning device 20 receives inputs of mixed voices including voices from a plurality of sound sources. However, unlike the mixed voice input to the extraction device 10, the mixed voice input to the learning device 20 is assumed to have known sound sources for each component. That is, it can be said that the mixed voice input to the learning device 20 is labeled training data.

The learning device 20 extracts a voice of each sound source or a voice of a target sound source from the mixed voice. Then, the learning device 20 trains the model based on the training data and the extracted voices of each sound source. For example, the mixed voice input to the learning device 20 may be obtained by combining voices of a plurality of speakers recorded individually.

The interface unit 21 is an interface for inputting and outputting data. For example, the interface unit 21 is an NIC. Moreover, the interface unit 21 may be connected to an output device such as a display, and an input device such as a keyboard.

The storage unit 22 is a storage device such as an HDD, an SSD, or an optical disc. Note that the storage unit 22 may be a semiconductor memory capable of rewriting data, such as a RAM, a flash memory, or an NVSRAM. The storage unit 22 stores an OS and various programs executed by the learning device 20.

As illustrated in FIG. 2, the storage unit 22 stores model information 221. The model information 221 is a parameter or the like for constructing a model. For example, the model information 221 is a weight, a bias, and the like for constructing each neural network that will be described later.

The control unit 23 controls the entire learning device 20. The control unit 23 is, for example, an electronic circuit such as a CPU, an MPU, or a GPU, or an integrated circuit such as an ASIC or an FPGA. Further, the control unit 23 includes an internal memory for storing programs or control data defining various processing procedures, and executes each type of processing using the internal memory.

Furthermore, the control unit 23 functions as various processing units by various programs operating. For example, the control unit 23 includes a signal processing unit 231, a loss calculation unit 232, and an update unit 233. Furthermore, the signal processing unit 231 includes a conversion unit 231a, a combination unit 231b, and an extraction unit 231c.

The signal processing unit 231 extracts the target voice from the mixed voice using the model constructed from the model information 221. The processing of each unit of the signal processing unit 231 will be described later.

The loss calculation unit 232 calculates a loss function based on the training data and the target voice extracted by the signal processing unit 231. The update unit 233 updates the model information 221 such that the loss function calculated by the loss calculation unit 232 is optimized.

The signal processing unit 231 of the learning device 20 has a function equivalent to that of the extraction device 10. Therefore, the extraction device 10 may be realized by using some of the functions of the learning device 20. Hereinafter, in particular, the description regarding the signal processing unit 231 is similar to that of the signal processing unit 131.

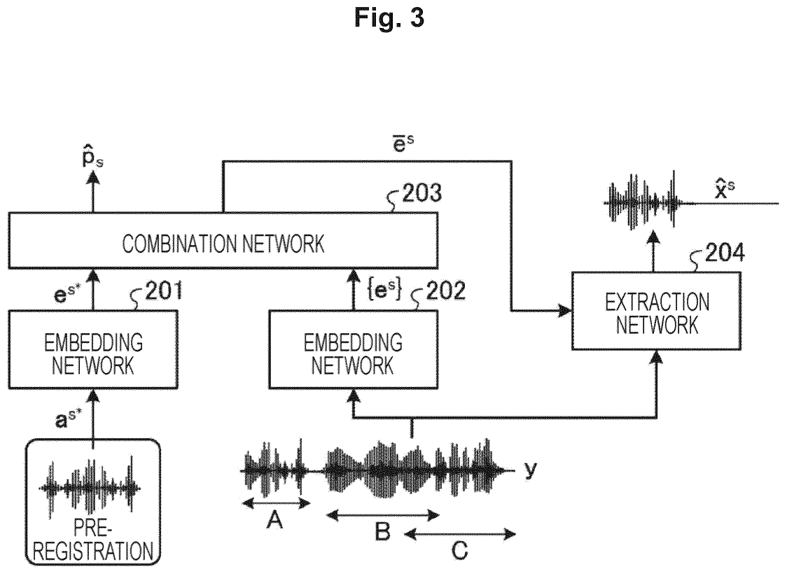

Processing of the signal processing unit 231, the loss calculation unit 232, and the update unit 233 will be described in detail. The signal processing unit 231 constructs a model as illustrated in FIG. 3 based on the model information 221. FIG. 3 is a diagram illustrating a configuration example of a model.

As illustrated in FIG. 3, the model includes an embedding network 201, an embedding network 202, a combination network 203, and an extraction network 204. The signal processing unit 231 outputs \hat{ }x^{s}, which is an estimation signal of the voice of the target speaker, using the model.

The embedding network 201 and the embedding network 202 are examples of an embedding neural network.

Furthermore, the combination network 203 is an example of a combination neural network. Furthermore, the extraction network 204 is an example of an extraction neural network.

The conversion unit 231a further converts a voice a^{s}* of the pre-registered sound source into an embedding vector e^{s}* using the embedding network 201. The conversion unit 231a converts a mixed voice y, of which sound sources for each component are known, into an embedding vector {e^{s}} for each sound source using the embedding network 202.

Here, the embedding network 201 and the embedding network 202 can be referred to as a network that extracts a feature quantity vector representing a voice feature of a speaker. In this case, the embedding vector corresponds to a feature quantity vector.

Note that the conversion unit 231a may or may not perform conversion using the embedding network 201. In addition, {e^{s}} is a set of embedding vectors.

Here, an example of a conversion method by the conversion unit 231a will be described. In a case where the maximum number of sound sources is fixed, the conversion unit 231a uses a first conversion method. On the other hand, in a case where the number of sound sources is any number, the conversion unit 231a uses a second conversion method.

### [First Conversion Method]

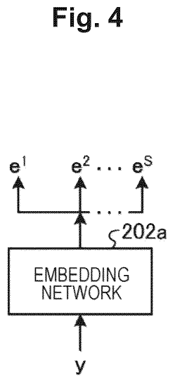

The first conversion method will be described. In the first conversion method, the embedding network 202 is expressed as an embedding network 202a illustrated in FIG. 4. FIG. 4 is a diagram for explaining an embedding network.

As illustrated in FIG. 4, the embedding network 202a outputs embedding vectors e¹, e², . . . , and e^{s} for each sound source based on the mixed voice y. For example, the conversion unit 231a can use a method similar to Wavesplit (Reference Literature: https://arxiv.org/abs/2002.08933) as the first conversion method. A method of calculating the loss function in the first conversion method will be described later.

### [Second Conversion Method]

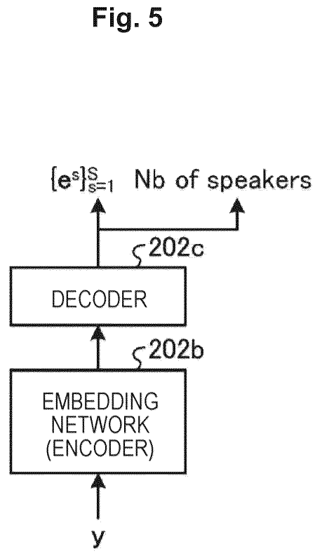

The second conversion method will be described. In the second conversion method, the embedding network 202 is expressed as a model including an embedding network 202b and a decoder 202c illustrated in FIG. 5. FIG. 5 is a diagram for explaining an embedding network.

The embedding network 202b functions as an encoder. The decoder 202c is, for example, a long short term memory (LSTM).

In the second conversion method, the conversion unit 231a can use a seq2seq model in order to deal with any number of sound sources. For example, the conversion unit 231a may separately output embedding vectors of sound sources exceeding a maximum number S (Nb of speakers).

For example, the conversion unit 131a may count the number of sound sources and obtain the number as an output of the model illustrated in FIG. 5, or may provide a flag to stop counting the number of sound sources.

The embedding network 201 may have a configuration similar to that of the embedding network 202. In addition, the parameters of the embedding network 201 and the embedding network 202 may be shared or may be separate.

The combination unit 231b combines the embedding vectors {e^{s}} using the combination network 203 to obtain a combined vector e^{s} ( immediately above e^{s}). Furthermore, the combination unit 231b may combine the embedding vector {e^{s}} converted from the mixed voice and the embedding vector e^{s}* converted from the voice of the pre-registered sound source.

Further, the combination unit 231b calculates \hat{ }pₛ (\hat{ } immediately above pₛ), which is the activity for each sound source, using the combination network 203. For example, the combination unit 231b calculates the activity by Formula (1).

$$\begin{matrix}[ Math . 1 ] & \\ {\hat{p}}_{s} = sigmoid ( \frac{{e}^{{s}^{* T}} {e}^{s}}{‖ {e}^{{s}^{*}} ‖ ‖ {e}^{s} ‖} ) & ( 1 )\end{matrix}$$

(1) The activity of Formula (1) may be valid only when the cosine similarity between e^{s}* and e^{s} is equal to or greater than the threshold value. Furthermore, the activity may be obtained by outputting from the combination network 203.

The combination network 203 may combine each embedding vector included in {e^{s}} by simply concatenating the embedding vectors, for example. Furthermore, the combination network 203 may perform combination after adding the weight based on the activity or the like to each embedding vector included in {e^{s}}.

The foregoing \hat{ }pₛ increases in a case where the voice is similar to the voice of the pre-registered sound source. Therefore, for example, in a case where \hat{ }pₛ does not exceed the threshold value with any pre-registered sound source among the embedding vectors obtained by the conversion unit 231a, the conversion unit 231a can determine that the embedding vector is of a new sound source that is not pre-registered. As a result, the conversion unit 231a can find a new sound source.

Here, in the experiment, the target voice can be extracted according to the present embodiment without performing the pre-registration of the sound source. At this time, the learning device 20 divides the mixed voice into blocks, for example, every 10 seconds, and extracts the target voice for each block. Then, for the n(n>1)th block, the learning device 20 deals with a new sound source discovered by the conversion unit 231a in the processing of the (n−1)th block as a pre-registered sound source.

The extraction unit 231c extracts the target voice from the mixed voice and the combined vector using the extraction network 204. The extraction network 204 may be similar to the main NN described in Cited Literature 1.

The loss calculation unit 232 calculates a loss function based on the target voice extracted by the extraction unit 231c. Furthermore, the update unit 233 updates the parameters of the embedding network 202 such that the loss function calculated based on the information regarding the sound sources for each component of the mixed voice and the target voice extracted by the extraction unit 231c is optimized.

For example, the loss calculation unit 232 calculates a loss function L as shown in Formula (2).

$$\begin{matrix}[ Math . 2 ] & \\ L = α {\sum }_{s}^{S} {L}_{signal} ( {\hat{x}}^{s} , {x}^{s} ) + β {L}_{speaker} ( {\{ s \}}_{s = 1}^{\hat{S}} , {\{ {\hat{e}}^{s} \}}_{s = 1}^{\hat{S}} ) + γ {L}_{embeddings} ( {\{ {\hat{e}}^{s} \}}_{s = 1}^{\hat{S}} , {\{ {e}^{s} \}}_{s = 1}^{S} ) + v {\sum }_{s}^{{S}^{′}} {L}_{activity} ( {\hat{p}}_{s} , {p}_{s} ) & ( 2 )\end{matrix}$$

L_{signal} and Lₛₚₑₐₖₑᵣ are calculated by a method similar to the conventional speaker beam described in Non Patent Literature 1, for example. α, β, γ, and ν are weights set as tuning parameters. x^{s} is a voice of which the sound source input to the learning device 20 is known. pₛ is a value indicating whether the speaker of the sound source s exists in the mixed voice. For example, in a case where the sound source s exists, pₛ=1, and otherwise, pₛ=0.

The L_{signal} will be described. x^{s} corresponds to e^{s} closest to e^{s} in {e^{s}}. The L_{signal} may be calculated for all sound sources or for some sound sources.

The Lₛₚₑₐₖₑᵣ will be described. S is the maximum number of sound sources. {s}ₛ₌₁^{\hat{ }s} is the ID of the sound source. Lₛₚₑₐₖₑᵣ may be a cross entropy.

L_{embedding} will be described. The loss calculation unit 232 may be calculated by the above-described Wavesplit method. For example, the loss calculation unit 232 can rewrite L_{embedding} into a permutation invariant (PIT) loss as in Formula (3).

$$\begin{matrix}[ Math . 3 ] & \\ {L}_{embeddings} ( {\{ {\hat{e}}^{s} \}}_{s = 1}^{\hat{S}} , {\{ {e}^{s} \}}_{s = 1}^{S} ) = {min}_{π ∈ Permutation ( S )} {\sum }_{s}^{S} {l}_{embedding} ( {s}^{s} , {\hat{e}}^{{π}_{s}} ) & ( 3 )\end{matrix}$$

S is the maximum number of sound sources. n is a permutation of sound sources 1, 2, . . . , and S. nₛ is a permutation element. \hat{ }e^{s} may be an embedding vector calculated by the embedding network 201 or an embedding vector preset for each sound source. In addition, \hat{ }e^{s} may be a one-hot vector. Furthermore, for example, L_{embedding} is a cosine distance or L2 norm between vectors.

Here, as shown in Formula (3), the calculation of the PIT loss requires calculation for each permutation element, and thus the calculation cost may be enormous. For example, in a case where the number of sound source is 7, the number of elements of the permutation is 7! and greater than 5000.

Therefore, in the present embodiment, by calculating Lₛₚₑₐₖₑᵣ by the first loss calculation method or the second loss calculation method described below, calculation of L_{embedding} using the PIT loss can be omitted.

### [First Loss Calculation Method]

In the first loss calculation method, the loss calculation unit 232 calculates P by Formulas (4), (5), and (6). Note that the method of calculating P is not limited to the method described here, and any method may be used as long as each element of the matrix P represents a distance (for example, cosine distance or L2 norm) between \hat{ }e^{s} and e^{s}.

[Math. 4]

Ê=[ê¹, . . . ,ê^{Ŝ}]∈R^{D×Ŝ} (4)

[Math. 5]

E=[e¹, . . . ,e^{S}]∈R^{D×S} (5)

[Math. 6]

P=Ê^{T}E∈R^{Ŝ×S} (6)

\hat{ }S is the number of pre-registered learning sound sources. Further, S is the number of sound sources included in the mixed voice. In Formula (4), the embedding vectors are arranged such that the activated (active) sound source is at the head in the mixed voice.

Subsequently, the loss calculation unit 232 calculates ˜P (˜ immediately above P) by Formula (7).

$$\begin{matrix}[ Math . 7 ] & \\ \tilde{P} = softmax ( P ) = {( \frac{{e}^{{P}_{i , j}}}{{\sum }_{i} {e}^{{P}_{i , j}}} )}_{i , j} & ( 7 )\end{matrix}$$

Formula (7) represents a probability that the embedding vectors of the sound source i and the sound source j correspond to each other, or represents a probability that Formula (8) is established.

[Math. 8]

p(sᵢ=sⱼ|e^{j},êⁱ) (8)

Then, the loss calculation unit 232 calculates an activation vector q by Formula (9).

$$\begin{matrix}[ Math . 9 ] & \\ {q}_{i} = {\sum }_{j} {( \tilde{P} )}_{i , j} , {q}_{i} ∈ [ 0 , S ] & ( 9 )\end{matrix}$$

A true value (training data) q^{ref} of the activation vector q is expressed by Formula (10).

[Math. 10]

q^{ref}=[1,1, . . . ,1,0, . . . ,0]^{T}∈R^{S×1} (10)

As a result, the loss calculation unit 232 can calculate Lₛₚₑₐₖₑᵣ as in Formula (11). Note that the function l(a,b) is a function that outputs a distance (for example, cosine distance or L2 norm) between the vector a and the vector b.

[Math. 11]

Lₛₚₑₐₖₑᵣ=l(q,q^{ref}) (11)

As described above, the loss calculation unit 232 can calculate the loss function based on the degree of activation for each sound source based on the embedding vectors for each sound source of the mixed voice.

### [Second Loss Calculation Method]

In the second loss calculation method, first, a matrix ˜P ∈R^{\hat{ }s×s} is considered. Each row of this matrix represents the allocation of the embedding vectors for each sound source of the mixed voice to the embedding vectors for each pre-registered sound source. Here, the loss calculation unit 232 calculates an embedding vector for target voice extraction as in Formula (12). ˜pᵢ is the i-th row of ˜P and corresponds to the weight in the attention mechanism.

[Math. 12]

ē^{s}= [symbol] ^{T}E (12)

The loss calculation unit 232 can express an exclusive constraint that associates each embedding vector with a different sound source by calculating Lₛₚₑₐₖₑᵣ=l(p,p^{ref}) similarly to the first loss calculation method.

In addition, L_{activity} is, for example, a cross entropy of activity \hat{ }pₛ and pₛ. From Formula (1), the activity \hat{ }pₛ is in the range of 0 to 1. As described above, pₛ is 0 or 1.

In the first loss calculation method or the second loss calculation method, the update unit 233 does not need to perform error back propagation for all the speakers. The first loss calculation method or the second loss calculation method is particularly effective in a case where the number of sound sources is large (for example, 5 or more). Furthermore, it is effective not only for the extraction of the first loss calculation method or the second loss calculation method target voice but also for sound source separation and the like.

### [Flow of Processing of First Embodiment]

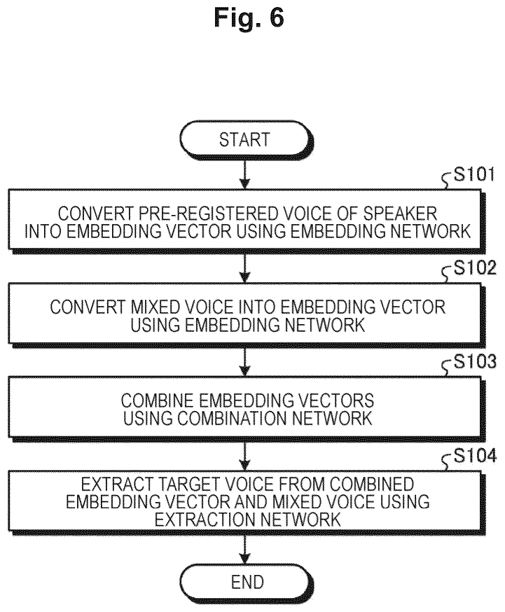

FIG. 6 is a flowchart illustrating a flow of processing of the extraction device according to the first embodiment. As illustrated in FIG. 6, first, the extraction device 10 converts the voice of the pre-registered speaker into an embedding vector using the embedding network 201 (step S101). The extraction device 10 may not execute step S101.

Then, the extraction device 10 converts the mixed voice into an embedding vector using the embedding network 202 (step S102). Next, the extraction device 10 combines the embedding vectors using the combination network 203 (step S103).

Subsequently, the extraction device 10 extracts a target voice from the combined embedding vector and mixed voice using the extraction network 204 (step S104).

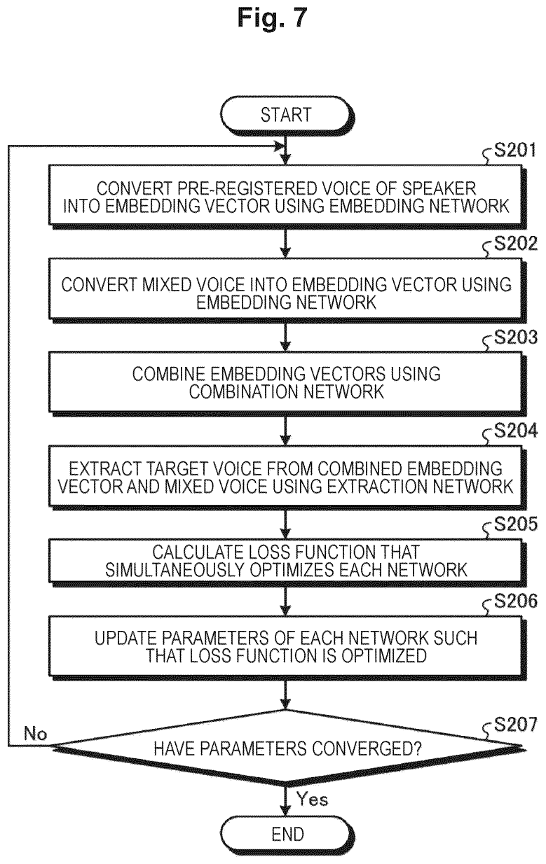

FIG. 7 is a flowchart illustrating a flow of processing of the learning device according to the first embodiment. As illustrated in FIG. 7, first, the learning device 20 converts the voice of the pre-registered speaker into an embedding vector using the embedding network 201 (step S201). The learning device 20 may not execute step S201.

Then, the learning device 20 converts the mixed voice into an embedding vector using the embedding network 202 (step S202). Next, the learning device 20 combines the embedding vectors using the combination network 203 (step S203).

Subsequently, the learning device 20 extracts a target voice from the combined embedding vector and mixed voice using the extraction network 204 (step S204).

Here, the learning device 20 calculates a loss function that simultaneously optimizes each network (step S205). Then, the learning device 20 updates the parameter of each network such that the loss function is optimized (step S206).

In a case where it is determined that the parameters have converged (step S207, Yes), the learning device 20 ends the processing. On the other hand, in a case of determining that the parameters do not converge (step S207, No), the learning device 20 returns to step S201 and repeats the processing.

### [Effects of First Embodiment]

As described above, the extraction device 10 converts the mixed voice, of which the sound sources for each component are known, into the embedding vectors for each sound source using the embedding network 202. The extraction device 10 combines the embedding vectors using the combination network 203 to obtain a combined vector. The extraction device 10 extracts a target voice from the mixed voice and the combined vector by using the extraction network 204.

In addition, the learning device 20 converts a mixed voice, of which the sound sources for each component are known, into the embedding vectors for each sound source using the embedding network 202. The learning device 20 combines embedding vectors using the combination network 203 to obtain a combined vector. The learning device 20 extracts the target voice from the mixed voice and the combined vector using the extraction network 204. The learning device 20 updates the parameters of the embedding network 202 such that the loss function calculated based on the information regarding the sound sources for each component of the mixed voice and the extracted target voice is optimized.

According to the first embodiment, by calculating the embedding vectors for each sound source, it is also possible to extract a voice of an unregistered sound source. Furthermore, the combination network 203 can reduce the activity in a time section in which the target speaker is not speaking in the mixed voice signal. In addition, since a time-by-time embedding vector can be obtained from the mixed voice, it is possible to cope with a case where the voice of the target speaker changes in the course of the meeting.

As described above, according to the present embodiment, it is possible to accurately and easily extract a target voice from a mixed voice.

The learning device 20 further converts the voice of the pre-registered sound source into an embedding vector using the embedding network 201. The learning device 20 may combine the embedding vector converted from the mixed voice and the embedding vector converted from the voice of the pre-registered sound source.

As described above, in a case where there is a sound source from which a voice can be obtained in advance, learning can be efficiently performed.

### [System Configuration and Others]

In addition, each component of each device that has been illustrated is functionally conceptual, and is not necessarily physically configured as illustrated. That is, a specific form of distribution and integration of individual devices is not limited to the illustrated form, and all or a part thereof can be functionally or physically distributed and integrated in any unit according to various loads, usage conditions, and the like. Further, all or any part of each processing function performed in each device can be realized by a central processing unit (CPU) and a program analyzed and executed by the CPU, or can be realized as hardware by wired logic.

Further, among pieces of processing described in the present embodiment, all or some of pieces of processing described as being automatically performed can be manually performed, or all or some of pieces of processing described as being manually performed can be automatically performed by a known method. In addition, the processing procedure, the control procedure, the specific name, and the information including various types of data and parameters illustrated in the above document and the drawings can be arbitrarily changed unless otherwise specified.

### [Program]

As an embodiment, the extraction device 10 and the learning device 20 can be implemented by causing a desired computer to install a program for executing the extraction processing or the learning processing of the above voice signal as package software or online software. For example, by causing an information processing device to execute the program for the above extraction processing, the information processing device can be caused to function as the extraction device 10. The information processing device mentioned here includes a desktop or notebook personal computer. Moreover, the information processing device also includes a mobile communication terminal such as a smartphone, a mobile phone, and a personal handyphone system (PHS), a slate terminal such as a personal digital assistant (PDA), and the like.

In addition, the extraction device 10 and the learning device 20 can also be implemented as a server device that sets a terminal device used by a user as a client and provides a service related to the above-described extraction processing or learning processing of the voice signal to the client. For example, the server device is implemented as a server device that receives a mixed voice signal as an input and provides a service for extracting a voice signal of a target speaker. In this case, the server device may be implemented as a web server, or may be implemented as a cloud that provides services by outsourcing.

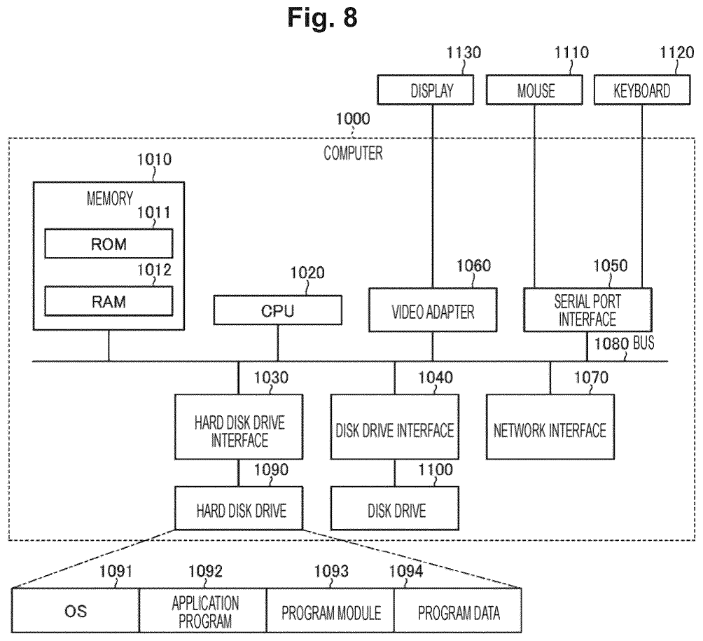

FIG. 8 is a diagram illustrating an example of a computer that executes the program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected with a disk drive 1100. For example, a removable storage medium such as a magnetic disk or an optical disc is inserted into the disk drive 1100. The serial port interface 1050 is connected with, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the extraction device 10 is implemented as the program module 1093 in which codes executable by a computer are described. The program module 1093 is stored in, for example, the hard disk drive 1090. For example, the program module 1093 for executing processing similar to the functional configurations in the extraction device 10 is stored in the hard disk drive 1090. Note that the hard disk drive 1090 may be replaced with an SSD.

In addition, setting data used in the processing of the above-described embodiment is stored, for example, in the memory 1010 or the hard disk drive 1090 as the program data 1094. Then, the CPU 1020 reads and executes the program module 1093 and the program data 1094 stored in the memory 1010 and the hard disk drive 1090 to the RAM 1012 as necessary.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

Extraction device
Learning device
11, 21 Interface unit
12, 22 Storage unit
13, 23 Control unit
121, 221 Model information
131, 231 Signal processing unit
131a, 231a Conversion unit
131b, 231b Combination unit
131c, 231c Extraction unit

1. An extraction device comprising:
conversion circuitry that converts a mixed sound into embedding vectors for each sound source using an embedding neural network;
combination circuitry that combines the embedding vectors using a combination neural network to obtain a combined vector; and
extraction circuitry that extracts a target sound from the mixed sound and the combined vector using an extraction neural network.

2. An extraction method, comprising:
converting a mixed sound into embedding vectors for each sound source using an embedding neural network;
combining the embedding vectors using a combination neural network to obtain a combined vector; and
extracting a target sound from the mixed sound and the combined vector using an extraction neural network.

3. A learning device comprising:
conversion circuitry that converts a mixed sound, of which sound sources for each component are known, into embedding vectors for each sound source using an embedding neural network;
combination circuitry that combines the embedding vectors using a combination neural network to obtain a combined vector;
extraction circuitry that extracts a target sound from the mixed sound and the combined vector using an extraction neural network; and
update circuitry that updates parameters of the embedding neural network such that a loss function calculated based on information regarding the sound sources for each component of the mixed sound and the target sound extracted by the extraction circuitry is optimized.

4. The learning device according to claim 3, wherein:
the conversion circuitry further converts a sound of a pre-registered sound source into an embedding vector using the embedding neural network, and
the combination circuitry combines the embedding vector converted from the mixed sound with the embedding vector converted from the sound of the pre-registered sound source.

5. The learning device according to claim 4, wherein:
the update circuitry updates the parameters of the embedding neural network such that a loss function calculated based on a degree of activation for each sound source, which is based on the embedding vectors for each sound source of the mixed sound, is optimized.

6. The learning device according to claim 4, wherein the update circuitry updates the parameters of the embedding neural network such that a loss function calculated based on a matrix representing allocation of the embedding vectors for each sound source of the mixed sound to the embedding vectors for each pre-registered sound source is optimized.

7. A learning method, comprising:
converting a mixed sound, of which sound sources for each component are known, into embedding vectors for each sound source using an embedding neural network;
combining the embedding vectors using a combination neural network to obtain a combined vector;
extracting a target sound from the mixed sound and the combined vector using an extraction neural network; and
updating parameters of the embedding neural network such that a loss function calculated based on information regarding the sound sources for each component of the mixed sound and the target sound extracted by the extracting is optimized.

8. A non-transitory Computer readable medium storing A program for causing a computer to function as the extraction device according to claim 1.

9. A non-transitory computer readable medium storing a program for causing a computer to perform the method of claim 2.

10. A non-transitory computer readable medium storing a program for causing a computer to function as the learning device according to claim 3.

11. A non-transitory computer readable medium storing a program for causing a computer to perform the method of claim 7.
